(19) United States
(12) Patent Application Publication
(10) Pub. No.: US 2008/0216970 A1
(43) Pub. Date: Sep. 11, 2008

(54) Sunshade assembly suitable for an arcuate window

(75) Inventor: Paul Lin, Tainan Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Macauto Industrial Co., Ltd., Tainan-Hsien (TW)

(21) Appl. No.: 11/716,196

(22) Filed: Mar. 8, 2007

(51) Int. Cl. B60J 1/20

(52) U.S. Cl. 160/262

(57) ABSTRACT

A sunshade assembly includes a pair of mounting seats, an arcuate rotatable shaft, and a flexible screen body. The rotatable shaft is tubular in shape, defines a curved rotational axis, is coupled rotatably to the mounting seats, and is formed with recesses so as to be rotatable about the curved rotational axis. The flexible screen body is wound on the rotatable shaft. The rotatable shaft is operable to rotate about the curved rotational axis for winding and unwinding the flexible screen body.

### BACKGROUND OF THE INVENTION

1. Field of the Invention

The invention relates to a sunshade assembly, more particularly to a sunshade assembly that is suitable for an arcuate window.

2. Description of the Related Art

In U.S. Pat. No. 6,079,474, there is disclosed a conventional sunshade assembly that includes an arcuate stationary shaft, a tubular rotatable shaft, and a flexible screen body. The rotatable shaft is sleeved rotatably on the stationary shaft. The flexible screen body is wound on the rotatable shaft. The rotatable shaft is operable to rotate about the stationary shaft in a first direction for unwinding the flexible screen body therefrom, and in a second direction opposite to the first direction for winding the flexible screen body thereon.

The aforementioned conventional sunshade assembly is disadvantageous in that in order for the rotatable shaft to be operative, the rotatable shaft can only be made of resilient material.

### SUMMARY OF THE INVENTION

Therefore, the object of the present invention is to provide a sunshade assembly that can overcome the aforesaid drawback of the prior art.

According to the present invention, a sunshade assembly comprises a shaft unit and a flexible screen body. The shaft unit includes mounting seats, and an arcuate rotatable shaft. The rotatable shaft is tubular in shape, defines a curved rotational axis, and has opposite first and second end portions, each of which is coupled rotatably to a respective one of the mounting seats. The rotatable shaft is formed with a plurality of recesses so as to be rotatable about the curved rotational axis. The flexible screen body is wound on the rotatable shaft. The rotatable shaft is operable to rotate about the curved rotational axis in a first direction for unwinding the flexible screen body therefrom, and a second direction opposite to the first direction for winding the flexible screen body thereon.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of a sunshade assembly according to the present invention;

FIG. 2 is a fragmentary sectional view to illustrate a rotatable shaft of the first preferred embodiment;

FIG. 3 is a schematic cut-away view of the first preferred embodiment to illustrate annular recesses in and annular pleats on the rotatable shaft;

FIG. 4 is a schematic cut-away view of the second preferred embodiment of a sunshade assembly according to the present invention;

FIG. 5 is a perspective view of the third preferred embodiment of a sunshade assembly according to the present invention; and

FIG. 6 is a perspective cut-away view to illustrate a rotatable shaft of the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

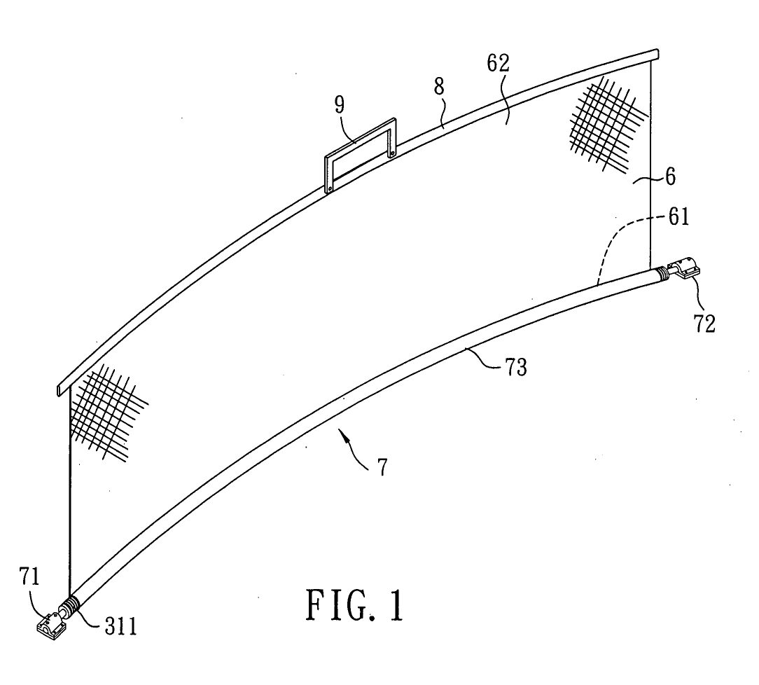

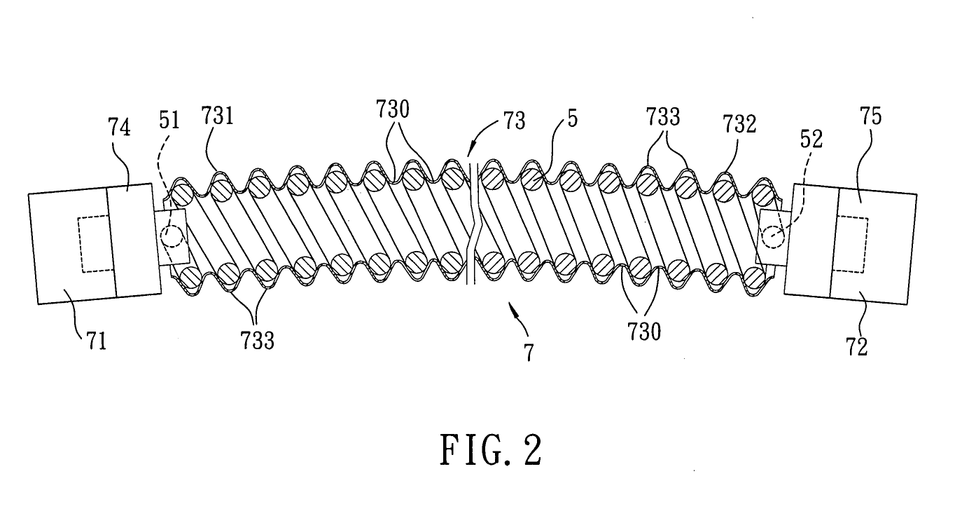

Referring to FIGS. 1 and 2, the first preferred embodiment of a sunshade assembly according to this invention is shown to include a shaft unit 7, and a flexible screen body 6.

The sunshade assembly of this embodiment is suitable for application to automobiles (not shown) installed with an arcuate window (not shown).

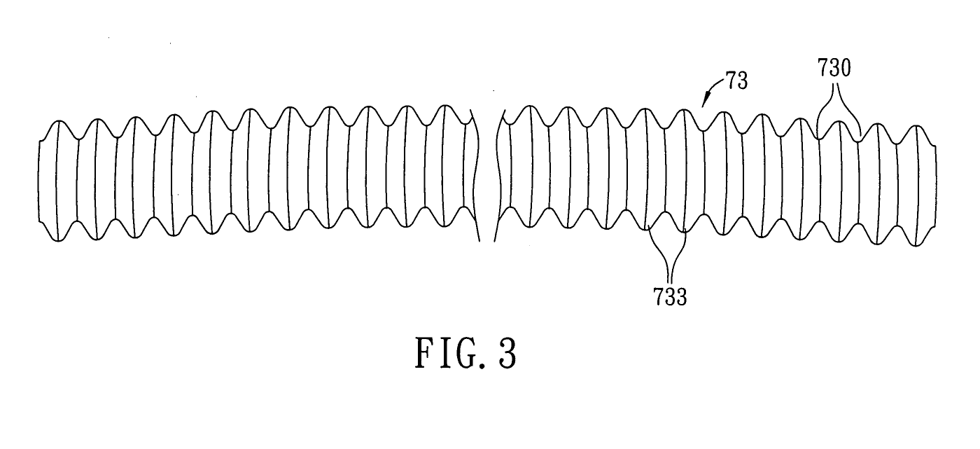

The shaft unit 7 includes first and second mounting seats 71, 72, and an arcuate rotatable shaft 73. Each of the first and second mounting seats 71, 72 is mounted adjacent to the arcuate window of the automobile. The rotatable shaft 73 is tubular in shape, defines a curved rotational axis, and has opposite first and second end portions 731, 732, each of which is coupled rotatably to a respective one of the first and second mounting seats 71, 72. In this embodiment, as best shown in FIG. 3, the rotatable shaft 73 is formed with a plurality of annular recesses 730 and a plurality of annular pleats 733, the annular recesses 730 and the annular pleats 733 being alternately arranged along the length of the rotatable shaft 73 such that the latter is rotatable about the curved rotational axis. Preferably, each of the annular recesses 730 is defined by a substantially V-shaped recess wall.

It is noted that since the rotatable shaft 73 is formed with the annular recesses 730 and the annular pleats 733 so as to be rotatable about the curved rotational axis, the rotatable shaft 73 may be made either of a rigid or a resilient material. In this embodiment, the rotatable shaft 73 is made from metal. Alternatively, the rotatable shaft 73 may be made from a plastic material or rubber.

The flexible screen body 6 is wound on the rotatable shaft 73, has a secured end 61 connected to the rotatable shaft 73, and a free end 62 opposite to the secured end 61 thereof.

The rotatable shaft 73 is operable to rotate about the curved rotational axis in a first direction for unwinding the flexible screen body 6 therefrom, and a second direction opposite to the first direction for winding the flexible screen body 6 thereon, in a manner that will be described hereinafter.

The shaft unit 7 further includes first and second inserts 74, 75. The first insert 74 is plugged rotatably into the first end portion 731 of the rotatable shaft 73 and is connected securely to the first mounting seat 71. The second insert 75 is plugged fittingly into the second end portion 732 of the rotatable shaft 73 and is connected rotatably to the second mounting seat 72, thereby permitting the second insert 75 to co-rotate with the rotatable shaft 73.

The shaft unit 7 further includes a biasing member 5 that biases rotation of the rotatable shaft 73 in the second direction. In particular, the biasing member 5, such as a torsion spring, is disposed in the rotatable shaft 73, and has opposite ends 51, 52 respectively connected to the first and second inserts 74, 75.

In operation, when it is desired to cover the arcuate window of the automobile, the free end 62 of the flexible screen body 6 is moved away from the rotatable shaft 73 by applying an external pulling force thereon. This results in unwinding of the flexible screen body 6 from the rotatable shaft 73 and rotation of the rotatable shaft 73 in the first direction against biasing action of the biasing member 5. Thereafter, when it is desired to uncover the arcuate window of the automobile, the free end 62 of the flexible screen body 6 is simply released from the external pulling force. This results in rotation of the rotatable shaft 73 in the second direction due to the biasing action of the biasing member 5 and winding of the flexible screen body 6 on the rotatable shaft 73.

The sunshade assembly further includes an arcuate rod 8 that is attached to and that extends along the length of the free end 62 of the flexible screen body 6, and a handle 9 that is connected to the arcuate rod 8. In this embodiment, the arcuate rod 8 has a curvature conforming to that of the rotatable shaft 73.

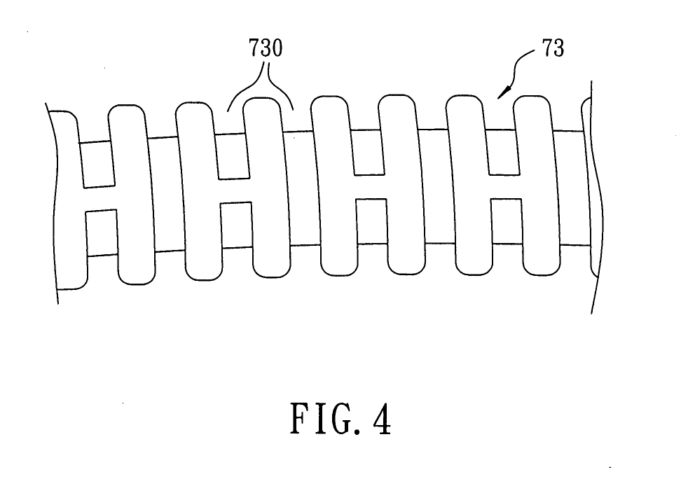

FIG. 4 illustrates the second preferred embodiment of a sunshade assembly according to this invention. When compared to the previous embodiment, each of the annular recesses 730 in the rotatable shaft 73 is defined by a U-shaped recess wall.

Since the operation of the sunshade assembly of this embodiment is similar to that described hereinabove in connection with the previous preferred embodiment, a detailed description of the same will be dispensed with herein for the sake of brevity.

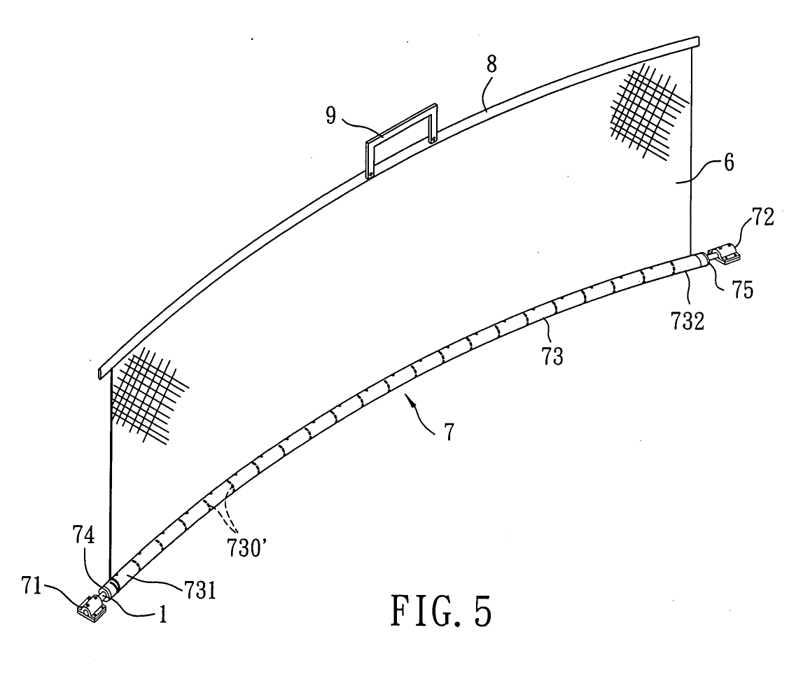

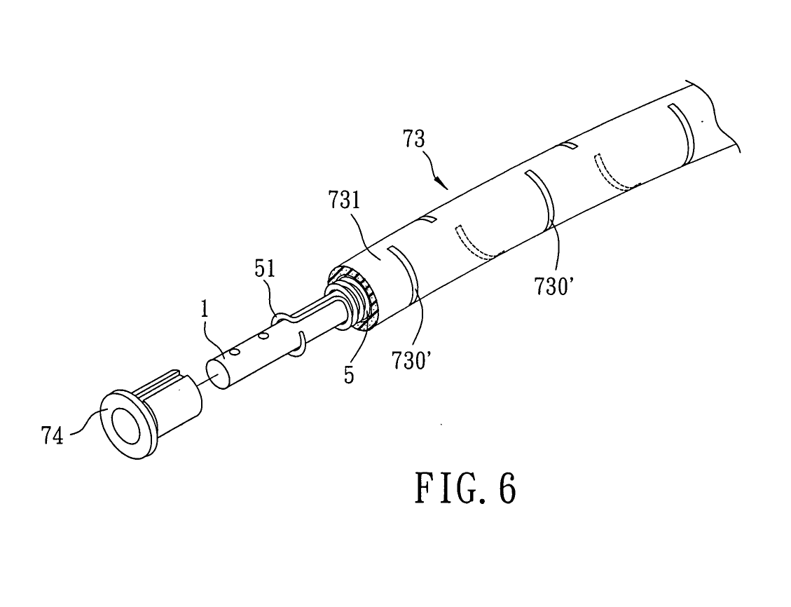

FIGS. 5 and 6 illustrate the third preferred embodiment of a sunshade assembly according to this invention. When compared to the previous embodiments, the rotatable shaft 73 is formed with a plurality of circumferentially extending recesses 730′ that are disposed along the length of the rotatable shaft 73 so as to be rotatable about the curved rotational axis.

Each of the first and second inserts 74, 75 is disconnected from the respective one of the first and second mounting seats 71, 72 and is plugged fittingly into a respective one of the first and second end portions 731, 732 of the rotatable shaft 73, thereby permitting the first and second inserts 74, 75 to co-rotate with the rotatable shaft 73.

The shaft unit 7 further includes an arcuate stationary shaft 1 on which the rotatable shaft 73 and the biasing member 5 are rotatably sleeved. In this embodiment, the stationary shaft 1 has opposite first and second end portions, each of which extends through a respective one of the first and second inserts 74, 75 and is connected securely to a respective one of the first and second mounting seats 71, 72.

Each of the opposite ends 51 of the biasing member 5 (only the end 51 of the biasing member 5 is shown in FIG. 6) is connected to a respective one of the stationary shaft 1 and the rotatable shaft 73.

Since the operation of the sunshade assembly of this embodiment is similar to that described hereinabove in connection with the first preferred embodiment, a detailed description of the same will be dispensed with herein for the sake of brevity.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A sunshade assembly, comprising:
a shaft unit including
a pair of mounting seats, and
an arcuate rotatable shaft that is tubular in shape, that defines a curved rotational axis, and that has opposite first and second end portions, each of which is coupled rotatably to a respective one of said mounting seats, said rotatable shaft being formed with a plurality of recesses so as to be rotatable about the curved rotational axis; and
a flexible screen body wound on said rotatable shaft;
wherein said rotatable shaft is operable to rotate about the curved rotational axis in a first direction for unwinding said flexible screen body therefrom, and a second direction opposite to the first direction for winding said flexible screen body thereon.

2. The sunshade assembly as claimed in claim 1, wherein said shaft unit further includes a biasing member for biasing rotation of said rotatable shaft in the second direction.

3. The sunshade assembly as claimed in claim 1, wherein each of said recesses in said rotatable shaft is annular in shape, said rotatable shaft being further formed with a plurality of annular pleats such that said recesses and said annular pleats are alternately arranged along the length of said rotatable shaft.

4. The sunshade assembly as claimed in claim 2, wherein said shaft unit further includes
a first insert that is plugged rotatably into said first end portion of said rotatable shaft and that is connected securely to one of said mounting seats; and
a second insert that is plugged fittingly into said second end portion of said rotatable shaft and that is connected rotatably to the other of said mounting seats, thereby permitting said second insert to co-rotate with said rotatable shaft,
each of said opposite ends of said biasing member being connected to a respective one of said first and second inserts.

5. The sunshade assembly as claimed in claim 1, wherein said rotatable shaft is made from one of metal and a plastic material.

6. The sunshade assembly as claimed in claim 2, wherein each of said recesses in said rotatable shaft extends circumferentially, said recesses being disposed along the length of said rotatable shaft, said shaft unit further including
an arcuate stationary shaft on which said rotatable shaft is rotatably sleeved, said stationary shaft having opposite first and second end portions, each of which is connected securely to a respective one of said mounting seats,
each of said opposite ends of said biasing member being connected to a respective one of said stationary shaft and said rotatable shaft.

7. The sunshade assembly as claimed in claim 6, wherein said shaft unit further includes
first and second inserts, each of which is plugged fittingly into a respective one of said first and second end portions of said rotatable shaft, thereby permitting said first and second inserts to co-rotate with said rotatable shaft,
each of said first and second end portions of said stationary shaft extending through a respective one of said first and second inserts.
